(19) United States
(12) Patent Application Publication
(10) Pub. No.: US 2020/0000137 A1
(43) Pub. Date: Jan. 2, 2020

(54) NUTRITIONAL COMPOSITION IN POWDER FORM PROVIDED IN SINGLE SERVING CAPSULES

(71) Applicant: SOCIETE DES PRODUITS NESTLES S.A., Vevey (CH)

(72) Inventors: Laurence Biehl, Thun (CH); Frederic Destaillats, Servon (CH); Alessandro Gianfrancesco, Munsingen (CH); Ute Haeberlein Schwan, Konolfingen (CH)

(21) Appl. No.: 16/489,009

(22) PCT Filed: Mar. 2, 2018
(86) PCT No.: PCT/EP2018/055181

§ 371 Date: Aug. 27, 2019

(30) Foreign Application Priority Data
Mar. 3, 2017 (EP) 17159218.1

(51) Int. Cl. A23L 33/00; A23L 33/12; A23P 20/10; A23P 10/30

(52) U.S. Cl. CPC A23L 33/40; A23P 10/30; A23P 20/11; A23L 33/12

(57) ABSTRACT

The present invention relates to a nutritional formula in powder form provided in single dose capsules, wherein the powder particles are at least partially coated with phospholipids. The nutritional formula has improved in-capsule dissolution properties compared to known nutritional formulae. The present invention also relates to a process for the production of such nutritional formula and to the use of phospholipids to improve the in-capsule dissolution of a nutritional formula.

### FIELD OF THE INVENTION

The present invention relates to a nutritional formula in powder form provided in single dose capsules, wherein the powder particles are at least partially coated with phospholipids. The nutritional formula has improved in-capsule dissolution properties compared to known nutritional formulae. The present invention also relates to a process for the production of such nutritional formula and to the use of phospholipids to improve the in-capsule dissolution of a nutritional formula.

### BACKGROUND OF THE INVENTION

Nutritional compositions in powder form intended for reconstitution with water, such as infant formulae or growing-up milks are provided in different formats. They are often provided as multiple doses in one single container such as a can or bag and dosed by the consumer using a spoon. Alternatively, nutritional compositions have been provided in single doses, for example in capsules.

WO2006/077259 describes a method of preparing a single serving of a nutritional composition comprising introducing water into a sealed disposable capsule containing a unit dose of the composition in powder or concentrate form so as to reconstitute the composition and operate opening means contained within the capsule to permit draining of the resulting liquid directly from the capsule into a receiving vessel. Such method is operated by the way of a dispenser. This method is advantageous because it is more convenient and safer than traditional spoon dosage from a multiple dose container.

However, dissolution of powdered nutritional formulae is more difficult in such methods using capsules and a dispenser than in methods wherein a care-giver reconstitutes a spoon of a nutritional formula in a vessel containing water, such as a feeding bottle. It is often observed that powder remains in the capsule. Incomplete dissolution of the nutritional formula from the capsule is disadvantageous, namely because this may lead to inaccurate dosing of the nutritional composition, the consumer receiving a smaller dose than planned. Powder remaining in the capsule is also very negatively perceived by consumers and is undesirable waste.

Parameters having an impact on the dissolution of milk powders have been extensively documented in the prior art. For example U.S. Pat. No. 3,773,519A teaches that the reconstitution properties of a powdered fat-containing milk product in cold water are improved by applying a coating of lecithin, possibly dissolved in fat.

However, solutions suitable to improve the dissolution of milk powders are not readily applicable to nutritional compositions, such as infant formulae or growing-up milks. Indeed, such nutritional compositions contain high amounts of fat (such as for example in the range of 25 to 35 wt %), which makes it particularly difficult to dissolve in capsule and in particular at low temperatures such as room temperature. In addition, nutritional compositions also have fatty acid profiles different from milk. These differences render the dissolution of nutritional compositions in powder form more difficult than milk powders. It is an object of the present invention to provide nutritional compositions that have good in-capsule dissolution.

The dissolution of nutritional compositions, such as infant formulae, in powder form has also been the object of intensive research and nutritional compositions such as infant formulae with good dispersibility in water exist. For example WO 2012/038913 describes a process for maintaining or improving a large number of properties (including wettability, rate of hydration, rate of dissolution and solubility) of a powder, such as an infant formula powder. The method comprises the combination of three different process steps: compressing the powder, milling the compressed powder and contacting the compressed or the milled powder with a surfactant, which may be selected from diverse forms of lecithin.

However, the problem of incomplete dissolution from capsules is observed even with powders which would readily dissolve when spooned into water from a multiple dose packaging. Usual infant formula powders that are readily dispersible in a feeding bottle by shaking do not properly dissolve when placed in capsules and reconstituted by filling the capsule with water and draining the liquid to a feeding vessel. There is therefore a need to further improve the dissolution of nutritional compositions in powder form and to find solutions targeted to solve the problem of the dissolution of nutritional compositions from single dose capsules (in-capsule dissolution).

WO2016/014492 describes an infant formula in a capsule comprising between 0.001 and 10% of a phospholipid. The presence of the phospholipid is taught to aid in the wettability of the powder, which affords homogeneous mixing of the nutritional compounds. This document however does not address the problem of powder that may remain in the capsule after reconstituting the infant formula with a dispensing system. In fact, when a powder such as described in this document is dissolved from a capsule, it is common that part of the powder remains un-dissolved in the capsule. It is thus needed to further improve the instant dissolution of nutritional powders in a capsule.

Further, it would be desirable to provide a solution to achieve good in-capsule dissolution at room temperature (25° C.), which is even more challenging than hot reconstitution. Dissolution at room temperature is advantageous for convenience and energy saving reasons because extensive heating of the water used for the reconstitution is avoided. It also avoids exposure of heat sensitive nutrients to high temperatures and thus promotes the nutritional quality of the reconstituted composition.

The present invention aims at solving the above-mentioned problems.

### SUMMARY OF THE INVENTION

In a first aspect, the invention provides a process for producing a single dose capsule containing a nutritional composition comprising the steps of
a) providing a nutritional composition in the form of a powder;
b) applying phospholipids on the surface of the powder after drying to at least partially coat the powder particles with the phospholipids; and
c) filling the powder obtained in step b) into a single dose capsule; and
d) sealing the capsule,
   characterized in that the nutritional composition in powder form comprises at least 0.3 wt % of phospholipids and wherein at least 20 wt % of the total phospholipid content of the powder is applied as a coating in step b).

In a second aspect, the invention provides a single dose capsule of a nutritional composition obtainable by the process of the invention.

In a third aspect, the invention provides a single dose capsule containing a nutritional composition in powder form, characterized in that the nutritional composition comprises at least 0.3 wt % of phospholipids and further characterized in that the powder particles are at least partially coated with at least 20 wt % of the total phospholipids content.

In a fourth aspect, the invention provides for the use of phospholipids to improve the in-capsule dissolution of a nutritional composition, characterized in that the phospholipids are added to the nutritional composition in an amount of at least 0.3 wt % and further characterized in that at least 20 wt % of the phospholipids are applied to the surface of the powder as a coating.

In a fifth aspect, the invention provides a method for preparing a single serving of a nutritional composition comprising introducing water into a sealed capsule containing a single dose of a powdered nutritional composition, so as to reconstitute the powdered composition and operate opening means contained within the capsule to permit draining of the resulting liquid directly from the capsule into a receiving vessel, characterized in that the nutritional composition comprises at least 0.3 wt % of phospholipids and further characterized in that the powder particles of the nutritional composition are at least partially coated with at least 20 wt % of the total phospholipids content.

### BRIEF DESCRIPTION OF THE DRAWINGS

FIG. 1: Photography of the capsules of the control (Example 1), comprising 0.2 wt % phospholipids in total and 0% of the phospholipids applied on the surface of the powder. Among 15 tested capsules, ten have insufficient in-capsule dissolution, with significant amounts of powder (more than 2 wt %) remaining in the capsules after reconstitution (see capsules circled in black).

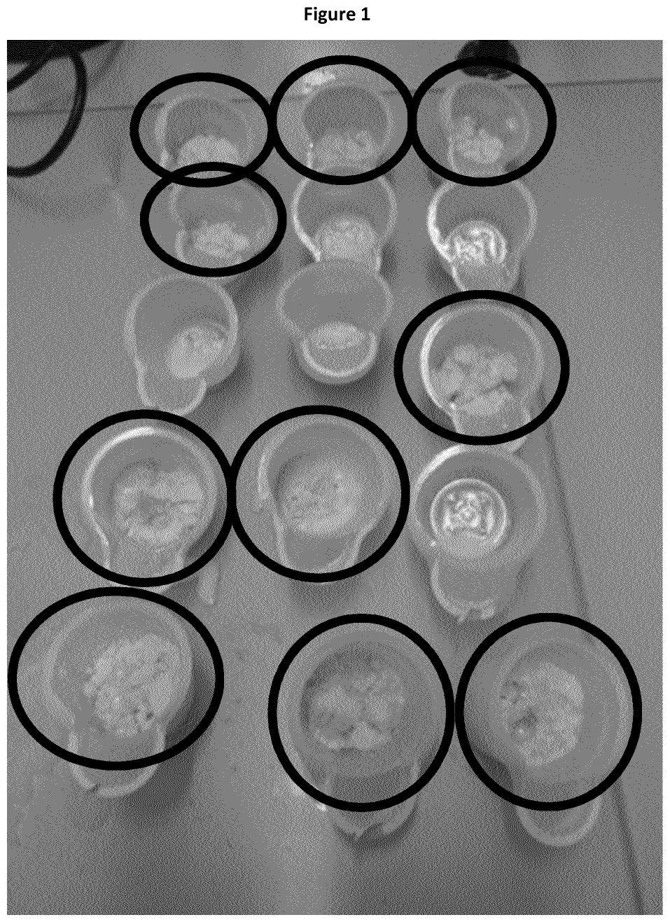

FIG. 2: Photography of the capsules of Sample A (Example 1), prepared with 0.4 wt % phospholipids in total and 50% of the phospholipids applied on the surface of the powder. The phospholipids applied on the surface are from lecithin source. Among 15 tested capsules, only one has insufficient in-capsule dissolution, with significant amounts of powder (more than 2 wt %) remaining in the capsule (see capsule circled in black).

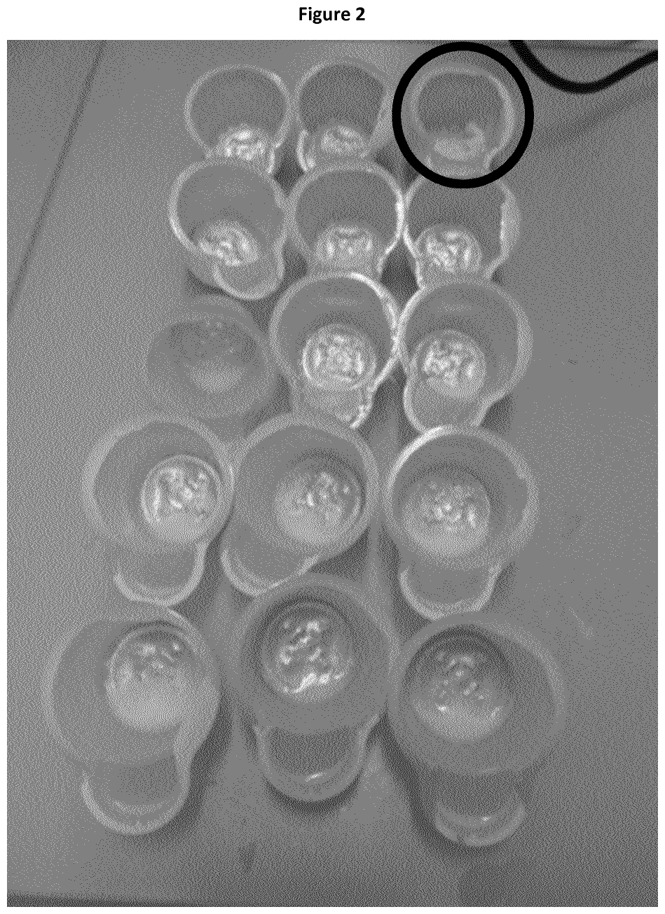

FIG. 3: Photography of the capsules of Sample B (Example 1), prepared with 0.6 wt % phospholipids in total, and 50% of the phospholipids applied on the surface of the powder. The phospholipids applied on the surface are from lecithin source. Among 15 tested capsules, all show satisfying in-capsule dissolution, with no significant amount (not more than 2 wt %) of powder remaining in the capsules.

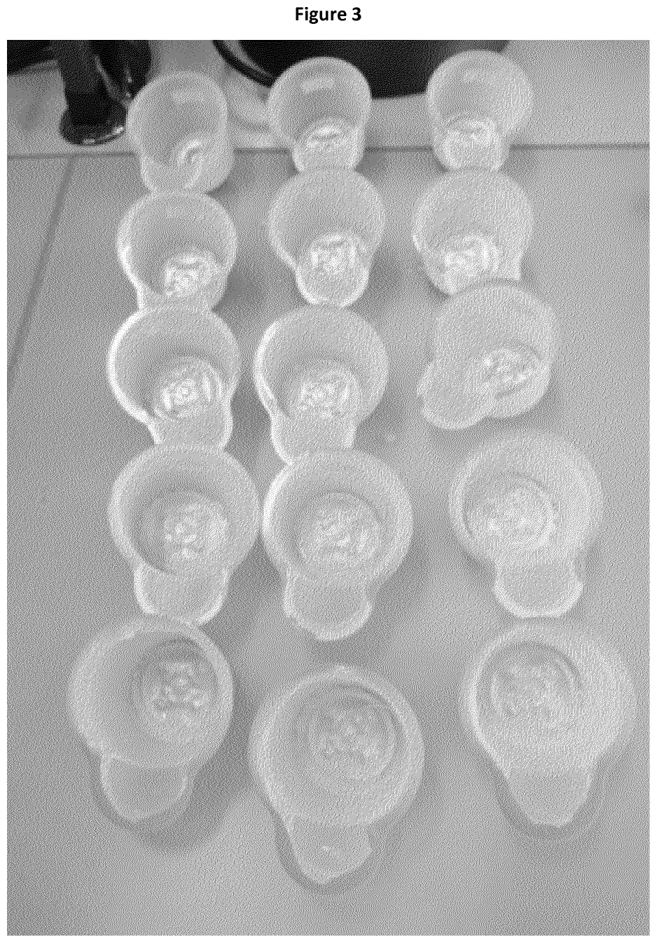

FIG. 4: Photography of the capsules of Sample C (Example 1), prepared with 0.4 wt % phospholipids in total in the infant formula powder, 0.2 wt % being provided in the powder and 0.2 wt % applied on the surface of the powder. Thus 50% of the phospholipids were applied on the surface of the powder. The phospholipids applied on the surface are from MFGM source. Among 15 tested capsules, all show satisfying in-capsule dissolution, with no significant amount (not more than 2 wt %) of powder remaining in the capsules.

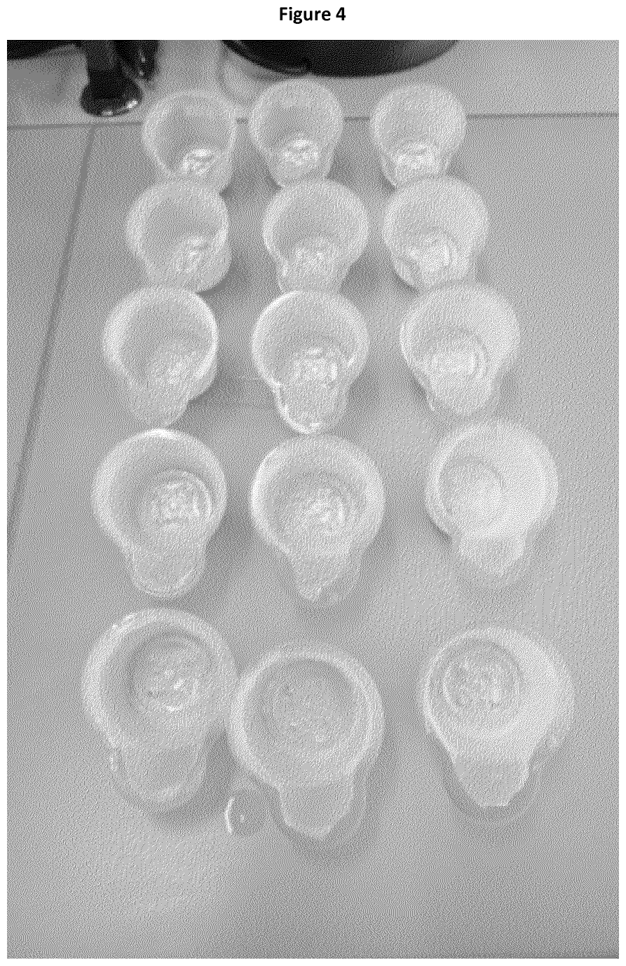

### DETAILED DESCRIPTION OF THE INVENTION

### Definitions

The term “nutritional composition” designates a product intended to provide a complete nutrition or a supplemental nutrition to an individual (i.e. to fulfil essential nutritional needs of such individual) and in which the prominent objective is to provide nutrition. A nutritional composition aims at providing specific nutrients to an individual having special nutritional needs, such as infants, young children, pregnant or lactating women, elderly people or people with adverse medical condition requiring special food (e.g. tube feeding compositions or compositions for paediatric subjects). Products in which the hedonic aspect is prominent and nutritional qualities are not of primary importance are excluded from the “nutritional products”. Nutritional compositions preferably comprise proteins, fats, carbohydrates and diverse micro-nutrients.

The term “capsule” designates a single dose and single use container for a powder composition suitable for being used to reconstitute the powder in dispensing system, wherein reconstitution of the powder in the dispensing system preferably comprises introducing water into a the sealed capsule such as to reconstitute the composition and operating opening means contained within the capsule to permit draining of the resulting liquid directly from the capsule into a receiving vessel.

The terms “surface of the powder particles” is intended here as the external surface of the particle that is exposed to the environment, as well as the layer inside the powder particle extending from the surface of the powder exposed to the environment to a distance of 10 μm, preferably 5 μm from the powder particle surface. These distances from the outer surface of the capsules typically include the standard depth taken into account in common analytical methods used to characterized powder surface properties, such as X-ray photoelectron spectroscopy (XPS) or Energy dispersive X-Ray spectroscopy (EDX).

The term “infant” refers to a child between birth and 12 month of age.

The term “young child” or “young children” refer to children from 12 months of age to 5 years, preferably to 3 years of age.

### Process for Producing a Single Dose Capsule Containing a Nutritional Composition

The present invention relates to a process for producing a single dose capsule containing a nutritional composition in powder form comprising the steps of
a) providing a nutritional composition in the form of a powder;
b) applying phospholipids as a coating on the surface of the powder to obtain a powder that is at least partially coated with the phospholipids;
c) filling the powder obtained in step b) into a single dose capsule; and
d) sealing the capsule,
   wherein the nutritional composition in powder form comprises at least 0.3 wt % of phospholipids and wherein at least 20 wt % of the total phospholipid content of the powder is applied as a coating in step b).

In step a), a nutritional composition in powder form is provided. Such nutritional powders can be any type of nutritional composition. Typically, the nutritional composition is intended to provide complete nutrition ora supplemental nutrition to an individual. Such nutritional compositions typically comprise proteins, fats, carbohydrates and diverse micro-nutrients. Preferably the individual is an infant, a young child, a pregnant or lactating woman or a woman desiring to get pregnant. More preferably, the individual is an infant or a young child, a pregnant woman or a lactating woman. Most preferably the nutritional composition is a complete nutrition for an infant or a young child.

The nutritional composition can be dried to a powder using any method known in the art such as spray-drying, freeze-drying, fluid bed drying, vacuum belt drying or roller drying. Preferably the nutritional composition is dried to a powder by spray-drying. The powder may then be subjected to post-drying agglomeration, for example in a fluid bed. In a preferred embodiment, the powder is not compressed and/or milled.

In step b), phospholipids are applied on the surface of the nutritional composition in powder form. The phospholipids can be applied to the powder using any suitable technique such as spraying the phospholipids on the surface of the powder, or by pouring the phospholipid solution on the powder in a tumbler or high shear mixer. Preferably such phospholipids are applied by spraying on the surface of the powder. Spraying is performed by maintaining the phospholipids solution above its melting point, and pumping it through a high pressure or a bifluid nozzles where small liquid droplet are created. Typical pressure values are in the range of 80 to 300 bars for high pressure nozzles, and of 2 to 6 bar for the compressed air used by bifluid nozzles. The spraying can be performed immediately after the drying of the powder or at a later stage, eventually after storage and/or handling of the powder.

Any source of phospholipids can be used. Phospholipids can be applied on the surface of the powder as such or in the form of a solution or suspension. Alternatively, it can be applied to the surface of the powder in the form of a phospholipid source or in the form of a composition comprising such phospholipid source. Phospholipid sources are well known to the person skilled in the art, such as lecithin, milk fat globule membrane (MFGM) or egg yolk. For certain categories of consumers, specific sources of phospholipids are preferred. For example, for infants and young children, phospholipid sources such as lecithin and milk fat globule membrane (MFGM) are preferred. Those phospholipid sources are thus preferred for the purpose of the present invention.

In order to improve the dissolution of the powder in the single use capsule (in-capsule dissolution), it is preferred that the nutritional composition in powder form comprises at least 0.4 wt %. In another embodiment, from 0.3 to 1 wt %, preferably from 0.4 to 1 wt %, more preferably from 0.4 to 0.8 wt %, most preferably from 0.4 to 0.6 wt % of phospholipids.

The in-capsule dissolution is particularly efficient because a significant part of the phospholipids is applied as a coating on surface of the powder, preferably as a result of spraying the phospholipids onto the surface of the powder. Preferably, at least 30 wt %, preferably at least 40 wt %, more preferably at least 50 wt % of the phospholipids are applied as a coating. In another embodiment, from 30 to 80 wt %, preferably from 40 to 80 wt %, more preferably 50 to 70 wt %, most preferably 50 to 66.5 wt % of the phospholipids are applied as a coating on the surface of the powder. In a preferred embodiment, an amount of at least 0.2 wt % of phospholipids, based on the total weight of the composition, is provided in admixture with the other ingredients of the nutritional composition, in order to have a good emulsification of the composition before it is dried.

Application of phospholipids on the surface of the powder has the effect of forming a coating on at least part of the surface of the powder. The present inventors have shown that the presence of phospholipids on surface of the particles or within the first 5 to 10 pm inside the particles have a strong impact on the surface properties of the powder and in particular on its dispersibility in water.

Applying the phospholipid on the surface of the powder achieves at least partial coating of the powder particles with phospholipids. The phospholipids spread on the whole or part of the surface of the powder particles. The part of the total surface of the powder that is actually covered by phospholipids may depend on the surface properties of the powder or of the shape of the particles for example. Preferably, at least 10%, more preferably at least 20%, more preferably at least 30%, more preferably at least 40%, more preferably at least 50%, more preferably at least 60%, more preferably at least 70%, more preferably at least 80%, even more preferably at least 90% and most preferably 100% of the surface of the powder is coated with phospholipids.

In step c) the powder is filled in the capsule using any known powder filling technique.

In step d) the capsule is sealed using any known means.

### Single Dose Capsule

The invention provides a single dose capsule that is obtainable or obtained by the process of the invention, as described above. Such single dose capsules are advantageous in that the in-capsule dissolution of the powder is improved compared to capsules comprising powder that has not been coated with phospholipids, preferably in the amounts indicated above in the process section.

The in-capsule dissolution is defined as the percentage of the capsules in which at least 95% of the powder present in the capsule is dissolved when the nutritional composition is reconstituted by introducing water at 25° C. into the sealed capsule and draining the resulting liquid directly from the capsule into a receiving vessel. Preferably the in-capsule dissolution refers to the percentage of capsules in which at least 97%, more preferably at least 98% of the powder is dissolved in the conditions mentioned above. The capsules are advantageously characterized by an in-capsule dissolution of at least 90%, preferably at least 92%, more preferably at least 94%, more preferably at least 96%, even more preferably at least 98%, most preferably 100%.

The dissolution of powders in capsules in such conditions is much more difficult than in a traditional feeding bottle, because there is no shaking in the bottle, which would help dissolution. Also, the mechanical forces applied to the powder at the time of filling the powder in the capsules has a negative impact on the solubility of the powder. Another challenge for in-capsule dissolution is that it may be required to dissolve the powder with water at room temperature, for example tap water. Applying phospholipids on the surface of the powder particle enables to overcome the above difficulties.

As a result of the process described above, the single dose capsule containing a nutritional composition in powder form it is preferably characterized in that the nutritional composition in powder form comprises at least 0.3 wt %, preferably at least 0.4 wt % of phospholipids, based on the total weight of the infant formula powder. In another embodiment, the nutritional composition in powder form comprises from 0.3 to 1 wt %, preferably from 0.4 to 1 wt %, more preferably from 0.4 to 0.8 wt %, most preferably from 0.4 to 0.6 wt % of phospholipids, based on the total weight of the infant formula powder.

The total amount of phospholipid in the powder is distributed in two parts. One part of the phospholipids is provided in the nutritional composition recipe and is homogeneously distributed in the powder particles. The second part of the phospholipids is present as a coating on the surface of the powder particles.

The in-capsule dissolution is particularly efficient because a significant part of the phospholipids is present as a coating on at least part of the surface of the powder, such as preferably at least 20 wt %, more preferably at least 30 wt %, even more preferably at least 40 wt %, most preferably at least 50 wt % of the total phospholipids. In another embodiment, from 30 to 80 wt %, preferably from 40 to 80 wt %, more preferably from 50 to 70 wt %, most preferably 50 to 67 wt % of the phospholipids are present as a coating on at least part of the surface of the powder.

It is further preferred that a significant part of the surface of the powder and more preferably substantially the whole surface of the powder is coated with phospholipids. In an embodiment, at least 10%, preferably at least 20%, more preferably at least 30%, more preferably at least 40%, more preferably at least 50%, more preferably at least 60%, more preferably at least 70%, more preferably at least 80%, even more preferably at least 90% and most preferably 100% of the surface of the powder is coated with phospholipids.

In a preferred embodiment the powder is at least partially coated with lecithin, milk fat globule membrane (MFGM), egg yolk, or mixtures thereof, preferably with lecithin, MFGM or mixtures thereof, most preferably with lecithin or MFGM.

The nutritional composition in the single dose capsule is preferably selected from an infant formula, a follow-on formula, a growing-up milk, a nutritional product for a pregnant women or a nutritional product for lactating women. Preferably, it is selected from an infant formula and a follow-on formula. Such products have complex compositions

### Uses of Phospholipid Coating to Improve the In-Capsule Dissolution of a Nutritional Powder

The present invention advantageously provides for the use of a phospholipid coating to improve the in-capsule dissolution of a nutritional composition in powder form, characterized in that the phospholipids are added to the nutritional composition in an amount of at least 0.3 wt % and further characterized in that at least 20 wt % of the phospholipids are applied to the surface of the powder as a coating

In other words, the present invention also relates to a method of improving the in-capsule dissolution of a nutritional composition in powder form comprising the steps of

a) providing a nutritional composition in powder form;

b) spraying phospholipids on the surface of the powder;

c) filling the powder in a single dose capsule; and

d) sealing the single dose capsule.

The nutritional composition, phospholipids and in-capsule dissolution are as defined in any of the above-described embodiments.

### Method of Preparing a Single Serving of a Nutritional Composition

According to the present invention, a method is provided of preparing a single serving of a nutritional composition comprising introducing water into a sealed single use capsule according to any embodiment of the invention, so as to reconstitute the powdered composition and operate opening means contained within the capsule to permit draining of the resulting liquid directly from the capsule into a receiving vessel.

Preferably, the method is carried out using a preparation machine or system.

### Method of Providing a Nutrition to an Individual

According to another embodiment of the invention there is provided a method of providing a nutrition to an individual comprising preparing a single serving of a nutritional composition with the method of the invention, as described above, and feeding the individual with said single serving of a nutritional composition.

The individual can be any individual in need thereof. Preferably, the individual is selected from infants, young children, pregnant or lactating women or women desiring to get pregnant. Preferably, it is selected from infants, young children, pregnant or lactating women, most preferably it is selected from infants or young children.

The present invention will now be described in further details by the way of the following examples.

### EXAMPLE 1

An infant formula was prepared comprising 10% of protein, 60% of carbohydrates, 28% of fat and 0.2% of phospholipids. The infant formula was prepared with a standard process including homogenization and heat treatment. The infant formula was dried to a powder using a spray-drying process.

Several samples according to the invention were then prepared by spraying phospholipids on the surface of the infant formula powder. Two different sources of phospholipids were used for spraying on the surface: soy lecithin and milk fat globule membrane (MFGM). Soy lecithin (Cargill, The Netherlands) contained 40 wt % of phospholipid. MFGM (Lacprodan® MFGM (origin: Arla Foods Ingredients, Viby, Denmark) contained 8 wt % of phospholipids.

### Preparation of the Control

An amount of 28 g of the infant formula powder without any phospholipid applied on the surface was filled into individual plastic capsules and the capsules were sealed with a plastic foil.

Preparation of Sample A

The infant formula in powder form was coated with an amount of 0.5 wt % of lecithin, based on the total weight of the coated infant formula. The lecithin, which was in liquid form, was heated up and maintained at 45-50° C. during the whole coating process. The lecithin was sprayed onto the surface of the powder using a SolidLab (Glatt, Germany) fluid bed. The fluid bed was equipped with a bi-fluid nozzle placed at the bottom of the air distribution grid. The coating was applied as follows. An amount of 350 g of the infant formula powder was put inside the fluid bed. The powder was pre-heated at 50° C. for 5 minutes with an air flow of 20 m³ per hour. The lecithin solution was then sprayed for 10 to 15 minutes, with an air temperature of 60° C. and an air flow of 40 m³ per hour. The powder was then cooled down for 5 minutes in the fluid bed with an air temperature of 30° C. and an air flow of 40 m³ per hour.

An amount of 28 g of the coated infant formula powder was then filled in individual plastic capsules and the capsules were sealed with a plastic foil.

### Preparation of Sample B

Sample B was prepared in the same way as sample A, except that an amount of 0.75 wt % of lecithin, based on the total weight of the coated infant formula powder, was sprayed onto the surface of the powder in the fluid bed.

### Preparation of Sample C

The infant formula in powder form was coated with an amount of 2.5 wt % of MFGM. To do this, a 20% w/w aqueous solutions of MFGM was prepared by dissolving the MFGM powder in hot water at 80° C. under stirring for 45 minutes. The MFGM solution was then sprayed onto the surface of the powder using a SolidLab (Glatt, Germany) fluid bed. The fluid bed was equipped with a bi-fluid nozzle placed at the bottom of the air distribution grid. The coating was applied as follows. An amount of 350 g of the infant formula powder was put inside the fluid bed. The powder was pre-heated at 50° C. for 5 minutes with an air flow of 20 m³ per hour. The lecithin solution was then sprayed for 10 to 15 minutes, with an air temperature of 60° C. and an air flow of 40 m³ per hour. The powder was then cooled down for 5 minutes in the fluid bed with an air temperature of 30° C. and an air flow of 40 m³ per hour.

An amount of 28 g of the infant formula powder was then filled in individual plastic capsules and the capsules were sealed with a plastic foil.

### Assessment of the In-Capsule Dissolution

The capsules was inserted in an apparatus for the preparation of a reconstituted composition. The apparatus introduced water at 25° C. into the sealed capsules and operated openings provided on the bottom of the capsule to permit draining of the reconstituted composition directly in a beaker.

The same procedure was applied to 15 capsules for each sample and for the control. The capsules were weighed to determine the amount of powder that remained in the capsule after reconstitution. When the percentage of powder remaining in the capsule was of 2 wt % or less of the powder that was present in the capsule before reconstitution, the dissolution was considered as satisfactory. The percentage of capsules with satisfactory dissolution was determined for each of the samples and for the control. The results are summarized in Table 1 below:

TABLE 1
in-capsule dissolution of infant formula with phospholipid coating

| | | | Percentage | |
|---|---|---|---|---|
| | | Total | of | |
| | | phospholipid | phospholipid | |
| | Sprayed | concentration in | provided as | |
| Sample | phospholipid | the coated | a coating by | In-capsule |
| reference | source | powder | spraying | dissolution |
| Control | None | 0.2% | 0% | 40% |
| Sample A | Lecithin¹⁾ | 0.4% | 50% | 93 |
| Sample B | Lecithin¹⁾ | 0.6% | 66.7% | 100% |
| Sample C | MFGM²⁾ | 0.4% | 50% | 100% |

¹⁾Soy lecithin, origin: Cargill, the Netherlands
²⁾Lacprodan ® MFGM, origin: Arla Foods Ingredients, Viby, Denmark.

This example shows that the in-capsule dissolution is improved by spraying phospholipids on the surface of the infant formula powder.

### EXAMPLE 2

The wettability of Samples A and C and of the Control was measured, by pouring 25 g of powders on 150 mL water at 25° C., and measuring with a stopwatch the time needed until the last granules are visually immerged in water. The results are reported in Table 2 below.

TABLE 2
Results of the wettability experiment

| | Control | Sample A | Sample C |
|---|---|---|---|
| D₁₀ (μm) | 67 | 69 | 93 |
| D₅₀ (μm) | 153 | 158 | 198 |
| D₉₀ (μm) | 294 | 317 | 381 |
| Wettability (s) | 46 | 25 | 16 |

This example provides evidence that the wettability of the powder with additional phospholipids sprayed on the surface is improved.

1. A process for producing a single dose capsule containing a nutritional composition in powder form comprising the steps of
a. providing a nutritional composition in the form of a powder;
b. applying phospholipids on the surface of the powder after drying to at least partially coat the powder particles with the phospholipids;
c. filling the powder obtained in step b) into a single dose capsule; and
d. sealing the capsule,
wherein the nutritional composition in powder form comprises at least 0.3 wt % of phospholipids, based on the total weight of the nutritional composition and further characterized in that at least 20 wt % of the total phospholipid content of the powder is applied as a coating in step b).

2. A process according to claim 1, wherein the phospholipids are applied in the form of a phospholipid source selected from the group consisting of lecithin, milk fat globule membrane (MFGM) and mixtures thereof.

3. (canceled)

4. A single dose capsule containing a nutritional composition in powder form, wherein the nutritional composition comprises at least 0.3 wt % of phospholipids, based on the total weight of the nutritional composition, and the powder particles are at least partially coated with at least 20 wt % of the total phospholipids content.

5. A single dose capsule according to claim 4 having an in-capsule dissolution of at least 90%, when the nutritional composition is reconstituted by introducing water at 25° C. into the sealed capsule and draining the resulting liquid directly from the capsule into a receiving vessel.

6. A single dose capsule according to claim 4, wherein the phospholipids at the surface of the nutritional composition powder are provided in a form selected from the group consisting of lecithin, milk fat globule membrane (MFGM) and mixtures thereof.

7. A single dose capsule according to claim 4, wherein at least 10% of the surface of the nutritional composition powder is coated with phospholipids.

8. A single dose capsule according to claim 4, wherein the nutritional composition is in a form selected from the group consisting of an infant formula, a follow-on formula, a growing-up milk and a nutritional composition for pregnant or lactating women.

9-10. (canceled)

11. A method of improving the in-capsule dissolution of a nutritional composition in powder form comprising the steps of
a. providing a nutritional composition in powder form;
b. spraying phospholipids on the surface of the powder;
c. filling the powder in a single dose capsule; and
d. sealing the capsule,
wherein the nutritional composition in powder form comprises at least 0.3 wt % of phospholipids, based on the total weight of the nutritional composition and further characterized in that at least 20 wt % of the total phospholipid content of the powder is applied as a coating in step b).

12. A method according to claim 11, wherein the phospholipids coating is provided in a form of a phospholipid source selected from the group consisting of lecithin milk fat globule membrane (MFGM) and mixtures thereof or in the form of a composition comprising lecithin, MFGM or mixtures thereof.

13-14. (canceled)
